(19) United States
(12) Patent Application Publication
(10) Pub. No.: US 2026/0080634 A1
(43) Pub. Date: Mar. 19, 2026

(54) MULTIPLAYER DIGITAL EFFECTS SYSTEM ON WEARABLE DEVICES

(71) Applicant: Snap Inc., Santa Monica, CA (US)

(72) Inventors: Ilteris Kaan Canberk, Los Angeles, CA (US); Luke Cartwright, New York, NY (US); Peng Deng, Playa Vista, CA (US); Ivan Fekete, Marina Del Rey, CA (US); Valeriia Fekete, Marina Del Rey, CA (US); Dmytro Kucher, Marina Del Rey, CA (US); Karen Stolzenberg, Venice, CA (US); Mathieu Emmanuel Vignau, Los Angeles, CA (US); Alexis Weintraub, Brooklyn, NY (US)

(21) Appl. No.: 18/946,520

(22) Filed: Nov. 13, 2024

Related U.S. Application Data
(60) Provisional application No. 63/694,991, filed on Sep. 16, 2024.

(51) Int. Cl. G06T 19/00; G02B 27/01; G06T 13/40

(52) U.S. Cl. CPC G06T 19/006; G02B 27/017; G06T 13/40; G06T 2219/024

(57) ABSTRACT

Examples relate to systems and methods for providing multiplayer experiences on a head-wearable apparatus, such as AR glasses. The system receives, by a first head-wearable apparatus, a short-range wireless signal from a second head-wearable apparatus, the short-range wireless signal including data that identifies a first digital effects session that is currently active on the second head-wearable apparatus. The system obtains, by the first head-wearable apparatus, information corresponding to the first digital effects session based on the data. The system, in response to obtaining the information corresponding to the first digital effects session, presents an indicator in a user interface of the first head-wearable apparatus, the indicator informing a user of the first head-wearable apparatus that one or more digital effects sessions are currently active on one or more head-wearable apparatuses within a threshold distance of the first head-wearable apparatus.

### CLAIM OF PRIORITY

This application claims the benefit of priority to U.S. Provisional Application Ser. No. 63/694,991, filed Sep. 16, 2024, which is incorporated herein by reference in its entirety.

### TECHNICAL FIELD

The present disclosure relates to head-wearable apparatus and, in some examples, to algorithms and systems to provide multiplayer experiences (e.g., augmented reality (AR) experiences) on the head-wearable apparatus.

### BACKGROUND

Some electronics-enabled eyewear devices, such as so-called smart glasses, allow users to interact with virtual content (e.g., augmented reality (AR) objects) while a user is engaged in some activity. Users wear the eyewear devices and can view a real-world environment through the eyewear devices while interacting with the virtual content that is displayed by the eyewear devices. Certain electronics-enabled eyewear devices (and other AR devices) allow users to interact with the virtual content (or real-world content) based on tracking eye gaze of the user (e.g., tracking/determining where the user is looking in the environment presented to the user).

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIGS. 5-9 illustrates user interfaces for providing multiplayer digital effects sessions on the head-wearable apparatus, according to some examples.

FIG. 10 is a flowchart illustrating a routine (e.g., a method or process), according to some examples, of providing multiplayer AR experiences on a head-wearable apparatus.

FIG. 11 illustrates a system including the head-wearable apparatus, according to some examples.

FIG. 12 is a diagrammatic representation of a machine in the form of a computer system within which a set of instructions may be executed to cause the machine to perform any one or more of the methodologies discussed herein, according to some examples.

FIG. 13 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Typical smart glasses platforms allow users to interact with various types of virtual content. Such platforms are configured to display the virtual content in the lenses of the smart glasses over a real-world environment seen through the lenses of the smart glasses. The current landscape of multiplayer augmented reality (AR) experiences using smart glasses faces significant challenges and inefficiencies that hinder widespread adoption and user satisfaction. Traditional methods of activating and configuring multiplayer AR experiences often involve cumbersome processes, leading to wasted time and resources. Users frequently encounter difficulties in synchronizing their devices, establishing shared virtual environments, and maintaining consistent experiences across multiple participants.

One inefficiency stems from the lack of seamless device discovery and connection protocols. Users often struggle to locate and pair their AR glasses with those of other participants, resulting in frustrating setup times and potential abandonment of the multiplayer experience altogether. This process typically requires manual intervention, such as entering codes or scanning QR patterns, which can be error-prone and time-consuming. Furthermore, the configuration of shared AR environments presents another significant challenge. Current systems often lack robust methods for aligning virtual content across multiple users' perspectives, leading to discrepancies in the placement and behavior of AR elements. This misalignment can severely impact the quality of the shared experience and diminish the overall effectiveness of multiplayer AR applications.

Resource allocation is another area where inefficiencies abound. Many existing multiplayer AR systems rely on centralized servers for processing and coordinating the shared experience, leading to increased latency and potential points of failure. This centralized approach also limits scalability and can result in degraded performance as the number of participants grows. Additionally, the activation of multiplayer modes in AR glasses often requires complex user interactions or app-specific procedures, creating a fragmented and inconsistent user experience across different applications. This lack of standardization not only confuses users but also increases the development burden on software creators, potentially stifling innovation in the field. Current multiplayer AR systems frequently struggle with maintaining persistent shared experiences over extended periods or across different sessions. The inability to easily save, resume, or transfer multiplayer AR configurations leads to repetitive setup processes and lost progress, further contributing to user frustration and resource waste.

The disclosed examples improve the efficiency of using the electronic device by providing an AR device (e.g., an eyewear device or head-wearable apparatus) that allows users to seamlessly engage in multiplayer digital effects sessions, such as multiplayer AR experiences. Specifically, the disclosed techniques receive, by a first head-wearable apparatus, a short-range wireless signal from a second head-wearable apparatus, the short-range wireless signal including data that identifies a first digital effects session that is currently active on the second head-wearable apparatus. The disclosed techniques obtain, by the first head-wearable apparatus, information corresponding to the first digital effects session based on the data. The disclosed techniques, in response to obtaining the information corresponding to the first digital effects session, present an indicator in a user interface of the first head-wearable apparatus, the indicator informing a user of the first head-wearable apparatus that one or more digital effects sessions are currently active on one or more head-wearable apparatuses within a threshold distance of the first head-wearable apparatus.

Specifically, the disclosed examples address the challenges mentioned previously by providing a seamless and efficient method for activating and configuring multiplayer AR experiences on head-wearable apparatuses. The disclosed examples utilize short-range wireless signals to automatically detect and identify active digital effects sessions on nearby devices, eliminating the need for manual pairing or complex setup procedures. This approach significantly reduces the time and effort required to initiate multiplayer experiences, addressing the issue of cumbersome activation processes. The disclosed examples obtain information about active sessions, including the list of current users and the name of the digital effects application being executed, allowing for easy discovery and joining of ongoing experiences. This feature tackles the challenge of device discovery and connection, making it simpler for users to locate and participate in nearby multiplayer AR sessions. Furthermore, the disclosed method includes automatic activation of the digital effects session on the joining device, adding the new user to the list of active participants without requiring additional user input. This streamlined process addresses the inefficiencies associated with complex user interactions and app-specific procedures for activating multiplayer modes.

The system also incorporates features for aligning shared AR environments, such as receiving mapping information from the initiating device and presenting an animation to guide the alignment process. This approach helps to resolve the challenge of misaligned virtual content across multiple users'perspectives, improving the consistency and quality of the shared experience. By implementing these features, the disclosed examples significantly reduce the inefficiencies and resource waste associated with current multiplayer AR glasses, providing a more user-friendly and seamless experience for activating and configuring multiplayer AR sessions.

Namely, the disclosed examples increase the efficiencies of the electronic device by reducing the amount of information and inputs needed to accomplish a task and reducing running complex image processing algorithms on the AR device. The disclosed examples further increase the efficiency, appeal, and utility of electronic AR devices, such as eyewear devices. While the disclosed examples are provided within a context of electronic eyewear devices, similar examples can be applied to any other type of AR wearable device, such as an AR hat, an AR watch, an AR belt, an AR ring, an AR bracelet, AR earrings, and/or an AR headset or other device that allows users to control or interact with content based on eye tracking or eye gaze direction, such as using an eye gaze vector.

### Networked Computing Environment

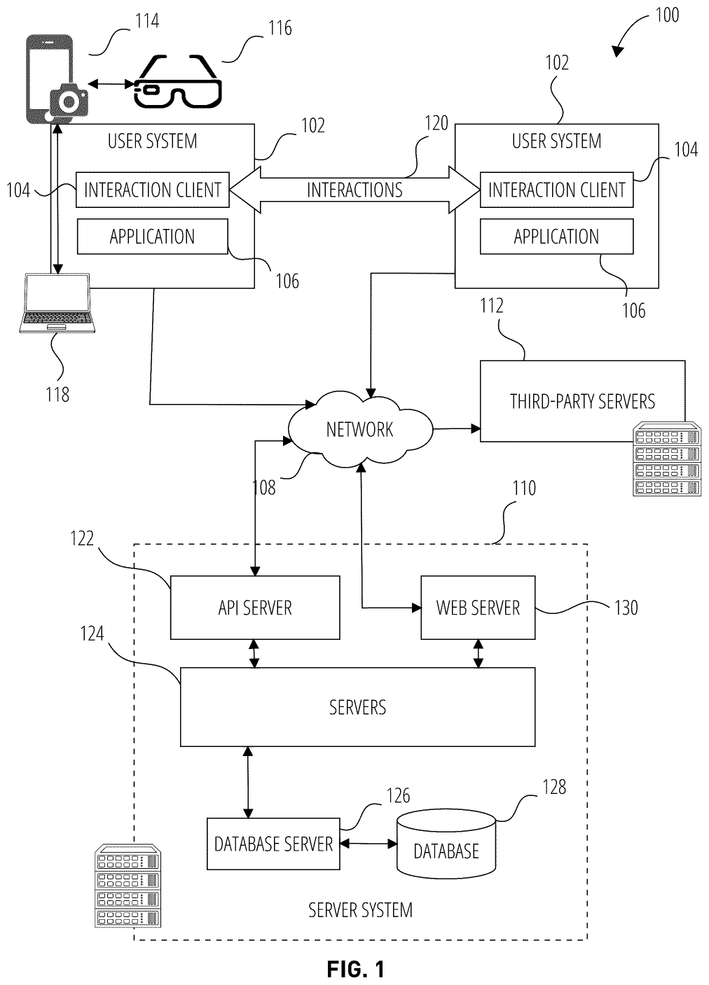

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

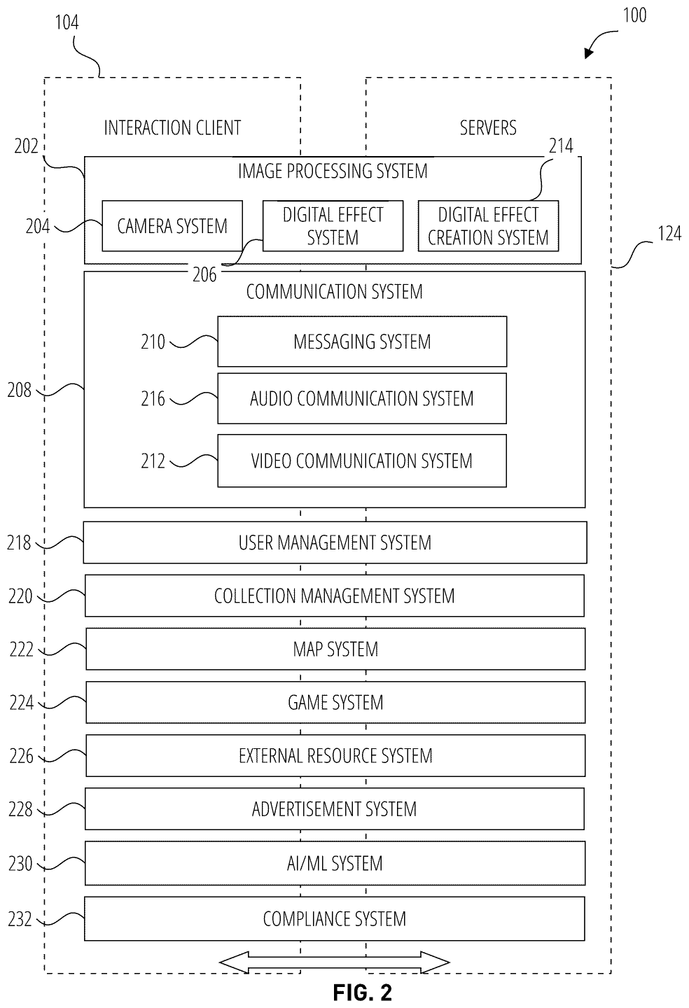

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that are enable shared or multiplayer digital effect applications and sessions on one or more head-wearable apparatuses 116, as discussed below.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 1102 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212. A digital effect application is an application configured to provide and display these digital effects and can enable users to engage in multiplayer digital effects sessions using respective head-wearable apparatuses 116. The digital effect application can be part of the application 106 (and/or interaction client 104) implemented by the user system 102 and/or the head-wearable apparatus 116.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

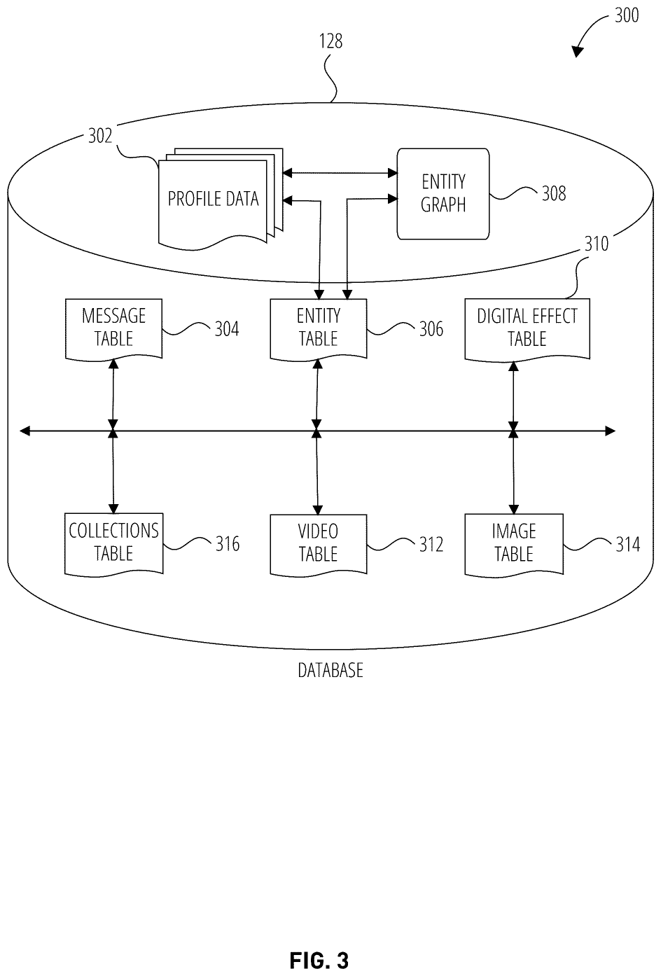

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include a list of active digital effects sessions and their respective locations and data including the list of users currently active on each digital effects session.

### Data Communications Architecture

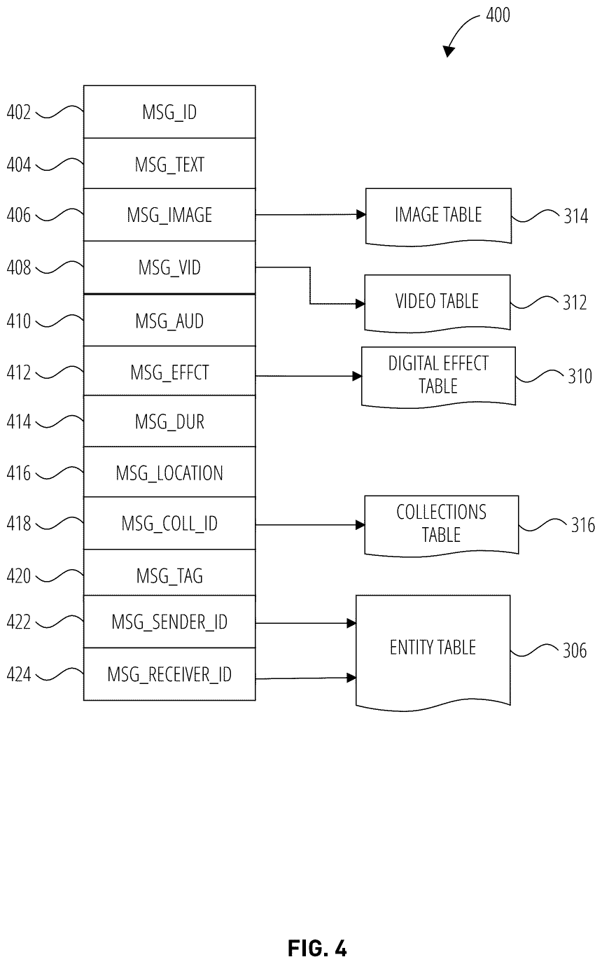

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

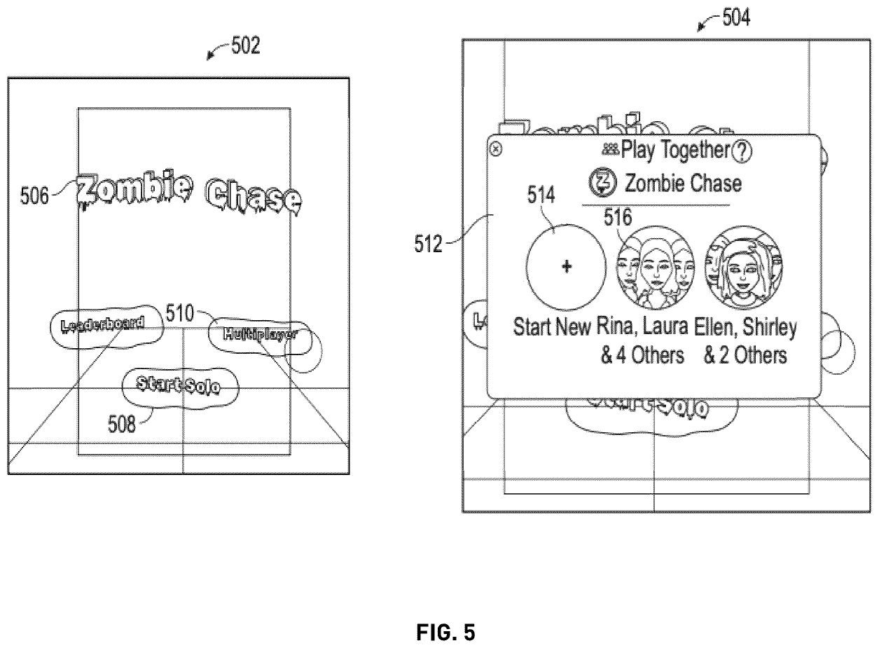

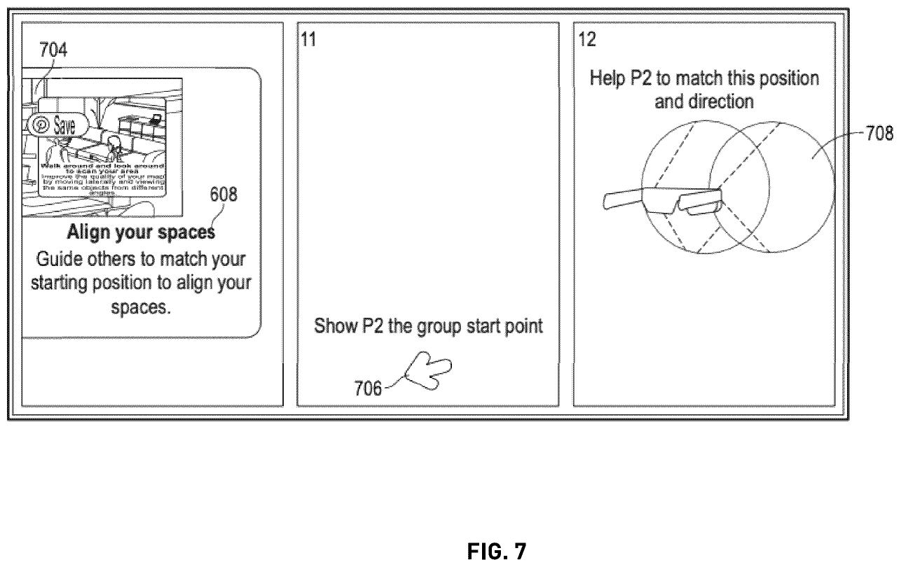

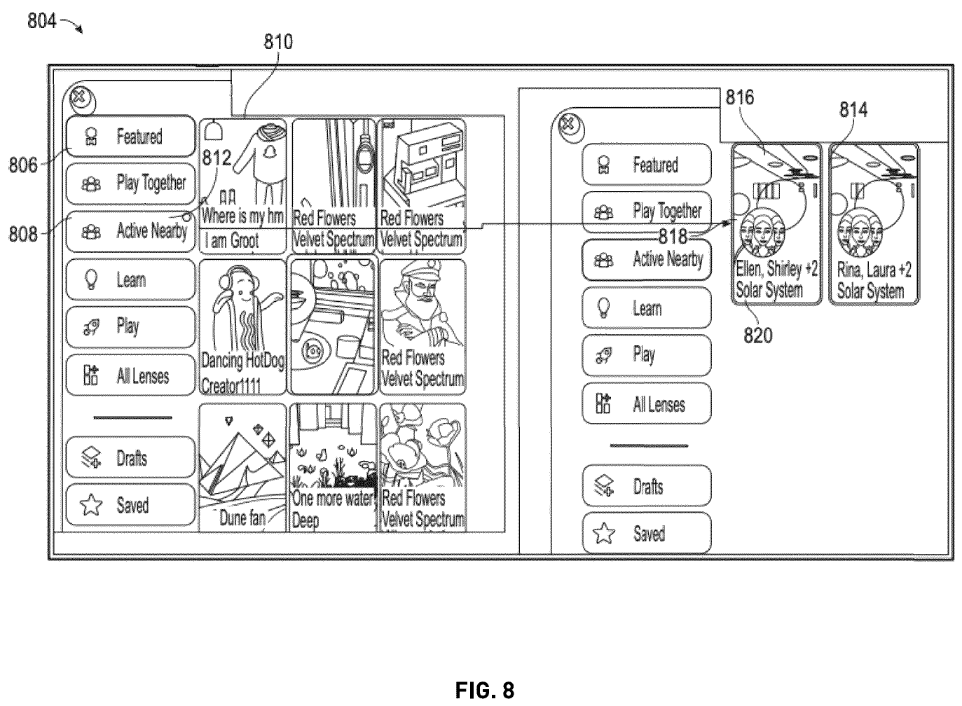

FIGS. 5-9 illustrates user interfaces for providing multiplayer digital effects sessions on the head-wearable apparatus, according to some examples. In some examples, a first user of a first head-wearable apparatus 116 can join a first digital effects session that has been activated or created by a second user of a second head-wearable apparatus 116. In order to initially activate the first digital effects session, the second user of the second head-wearable apparatus 116 can navigate a user interface that includes icons representing multiple digital effect applications. For example, the second user can navigate to a user interface 804 (FIG. 8) where a first option 806 associated with featured digital effects applications is selected. In response, a list of digital effect applications 810 is presented using respective icons or tiles.

The second head-wearable apparatus 116 can receive input that selects a particular icon or tile corresponding to the first digital effects application. In response, the second head-wearable apparatus 116 can present a first user interface 502. The first user interface 502 can include information, such as a name or title (e.g., a digital effects application name 506) for the first digital effects application. The first user interface 502 also includes various options for launching or activating the first digital effects application. For example, the first user interface 502 includes a first option 508. The first option 508 is associated with activating the first digital effects application in single player mode. In response to receiving input that selects the first option 508, the second head-wearable apparatus 116 activates and launches the first digital effects application only on the second head-wearable apparatus 116.

The first user interface 502 includes a second option 510. The second option 510 can be associated with activating the first digital effects application in multiplayer mode. In response to receiving input that selects the second option 510, the second head-wearable apparatus 116 presents the second user interface 504. The second user interface 504 includes a prompt 512 that identifies one or more currently active digital effects sessions with the same first digital effects application. For example, the second head-wearable apparatus 116 can access the database 128 and search the database 128 for active digital effects sessions that have the same identifier or unique identifier as the first digital effects application. The second head-wearable apparatus 116 retrieves any such sessions from the database 128 along with information that identifies the users currently engaged in each session. The second head-wearable apparatus 116 presents the active session icon 516 that identifies a particular digital effects session that includes the first digital effects application. The active session icon 516 presents a list of active participants in that active digital effects session. The second head-wearable apparatus 116 can receive input that selects the active session icon 516 and, in response, the second head-wearable apparatus 116 enables the second user to join that active session (e.g., if the second head-wearable apparatus 116 is within a threshold distance of one or more users that are engaged in that session).

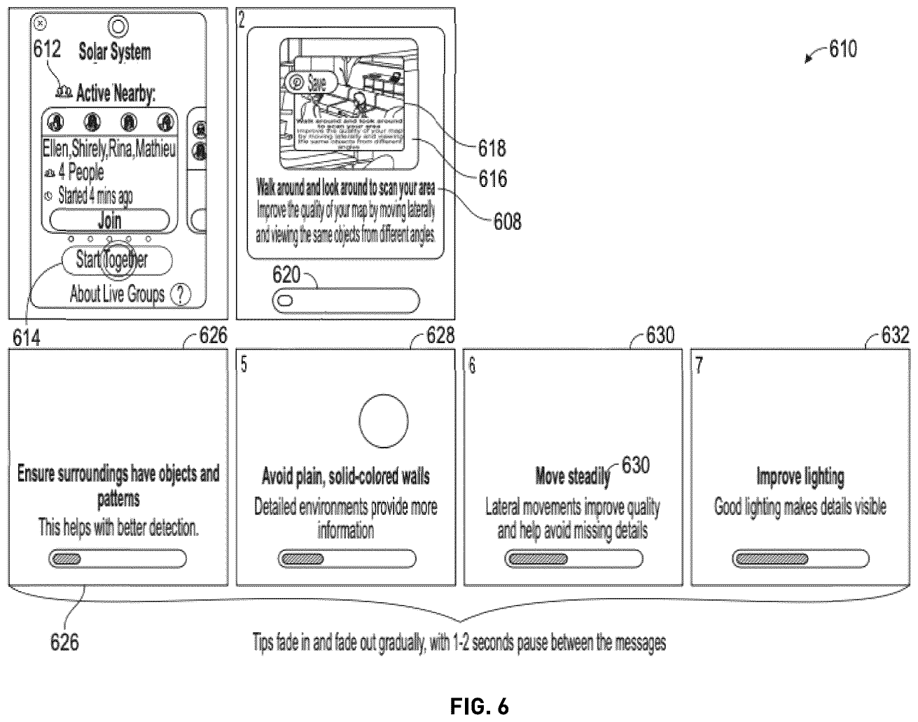

In some cases, the second head-wearable apparatus 116 receives input that selects the start new session option 514. In such cases, the second head-wearable apparatus 116 navigates the user to user interfaces 610 of FIG. 6. Specifically, the second head-wearable apparatus 116 presents an indicator 612 of the active nearby sessions and includes a start new session option 614. In response to receiving input that selects the start new session option 614 or in response to the selection of the start new session option 514, the second head-wearable apparatus 116 presents the mapping instructions 616. The mapping instructions 616 informs the user on how to map the real-world surroundings or environment of the second user. In some cases, the mapping instructions 616 includes an animation 618. The animation 618 presents multiple avatars in a room wearing AR glasses and shows how the avatars move their heads to map the real-world environment. As the second user moves their head around, a point cloud is generated to represent the real-world environment. Also, a 3D position in the real-world environment (e.g., GPS coordinates) is stored indicating where the second head-wearable apparatus 116 was positioned while the real-world environment was being mapped.

In some examples, a progress bar 620 is presented that informs the second user about progress in mapping the real-world environment. As the point cloud is updated with new points, the progress bar 620 animates as moving towards completion. When the point cloud reaches a threshold number of points, the progress bar 620 reaches the end and the mapping is completed. In some cases, the user interfaces 610 present various hints in the second head-wearable apparatus 116 while the real-world environment is being mapped. The second head-wearable apparatus 116 can present a first hint 626 and can then gradually fade the first hint 626 and present a second hint 628. This process is repeated until all of the hints including the third hint 630 and the fourth hint 632 are presented while the real-world environment is being mapped. The hints can be placed above the progress bar 620. The hints can include a hint to ensure the surroundings have objects and patterns to help with detection, a hint to avoid plain solid-colored walls, a hint to move steadily, and a hint to improve lighting conditions.

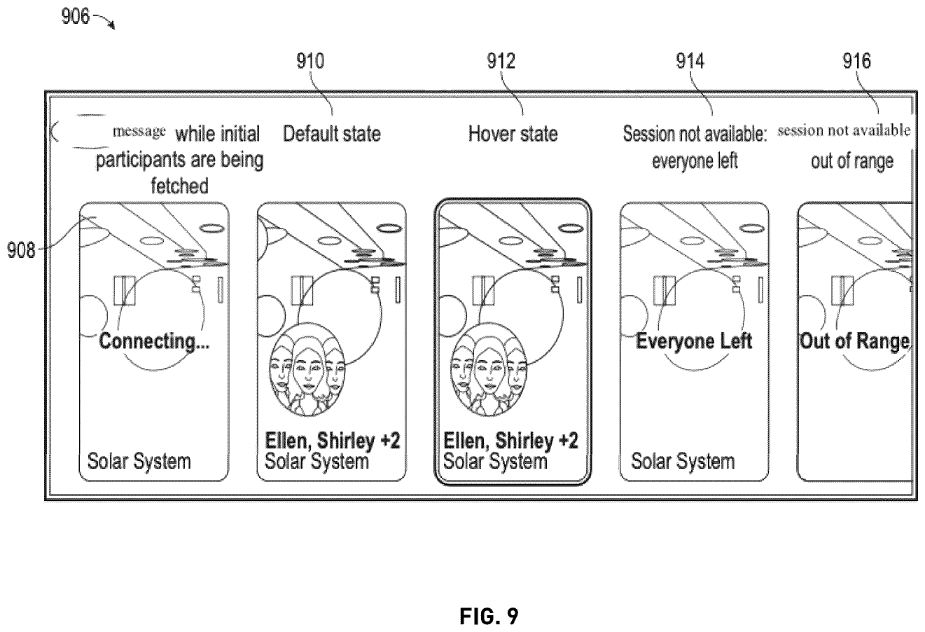

In some cases, the first user of the first head-wearable apparatus 116 may be presented with an icon or tile corresponding to the first digital effects session. The icon or tile can be greyed out while the first user is generating the mapping information for the real-world environment, such as by presenting the icon or tile in a first state 908 (shown in the interface 906 illustrated in FIG. 9). Once the mapping information is completed, the icon or tile can be enabled for selection by the first user on the first head-wearable apparatus 116 to join the first digital effects session, such as by presenting the icon or tile in the second state 910.

In response to receiving input from the first user from the first head-wearable apparatus 116 to join the first digital effects session, the second user on the second head-wearable apparatus 116 is presented with a instructions 704 to align the map of the real-world environment with the first head-wearable apparatus 116. In some cases, an animation is presented that identifies or includes multiple avatars walking around the room to align the mapping. In order to align the mapping, the second head-wearable apparatus 116 presents a direction indicator 706. The direction indicator 706 informs the second user the direction to walk in order to reach the stored 3D position where the second head-wearable apparatus 116 was positioned while the second user was mapping the real-world environment. An animation 708 can be provided showing two head-wearable apparatuses 116 meeting at a similar position. Once the second user helps position the first user in the same 3D position that the second user was in when the mapping information was created, the first user on the first head-wearable apparatus 116 is presented a similar set of interfaces as the user interfaces 610 presented to the second user to generate the mapping information of the real-world environment.

In some examples, in order to inform the first user (and other users who are within a threshold distance of the second user) about the active digital effects session, the second head-wearable apparatus 116 can periodically or continuously broadcast a session identifier that is associated with the first digital effects session that has been activated. The first head-wearable apparatus 116 can monitor for the broadcast session identifier (e.g., over Bluetooth, BLE, extended Bluetooth, and/or WiFi). In response to detecting the session identifier, the first head-wearable apparatus 116 can determine that the first head-wearable apparatus 116 is within a threshold distance of the second head-wearable apparatus 116.

The first head-wearable apparatus 116 can present the list of digital effect applications 810 to the first user in response to the first option 806 being selected. The second option 808 can be presented in the user interface 804 to allow the first user to browse any sessions that are within a threshold range of the first head-wearable apparatus 116. In some cases, the first user is notified about the first digital effects session when the first head-wearable apparatus 116 detects the signal that includes the session identifier. In such cases, the first head-wearable apparatus 116 modifies the second option 808 to include an indicator 812. The first head-wearable apparatus 116 can receive input that selects the second option 808 and, in response, presents a list of tiles representing different digital effects sessions that are active. For example, the first head-wearable apparatus 116 can present the icon 814 that represents the first digital effects session that was activated by the second user using the second head-wearable apparatus 116.

In some cases, the first head-wearable apparatus 116 can use the session identifier to search the database 128 for information about the first digital effects session. For example, the first head-wearable apparatus 116 can retrieve the name of the digital effects application that is running or being executed in the first digital effects session, a list of users in the first digital effects session, and a visual representation or image of the first digital effects application/session. In particular, the icon 814 can be generated by the first head-wearable apparatus 116 based on the retrieved information and can include the avatars 818 of the current active participants or users in the first digital effects session, image 816 representing the first digital effects application, and the name of digital effects application 820. In response to receiving input that selects the icon 814 (e.g., after hovering over the icon 814 causing the icon 814 to be presented in the fourth state 912), the first head-wearable apparatus 116 automatically and without presenting any additional options or interfaces navigate the user to access and join the first digital effects session associated with the icon 814.

In some cases, the digital effects session can monitor the active users in the session. When the list of active users in the digital effects session is empty, the icon 814 is updated to be presented in the fifth state 914. The icon 814 continues to be presented to the first user on the first head-wearable apparatus 116 in the fifth state 914 until the user navigates to a different interface, such as by selecting the first option 806 causing the list of digital effect applications 810 to be presented. When the first user then selects the second option 808, the icon 814 no longer appears as there are no active participants in the session.

In response to determining that the first head-wearable apparatus 116 has been moved to a place that transgresses the threshold distance to the second head-wearable apparatus 116, the icon 814 is updated to be presented in the sixth state 916. The sixth state 916 indicates to the first user that the user is out of range of the corresponding digital effects session.

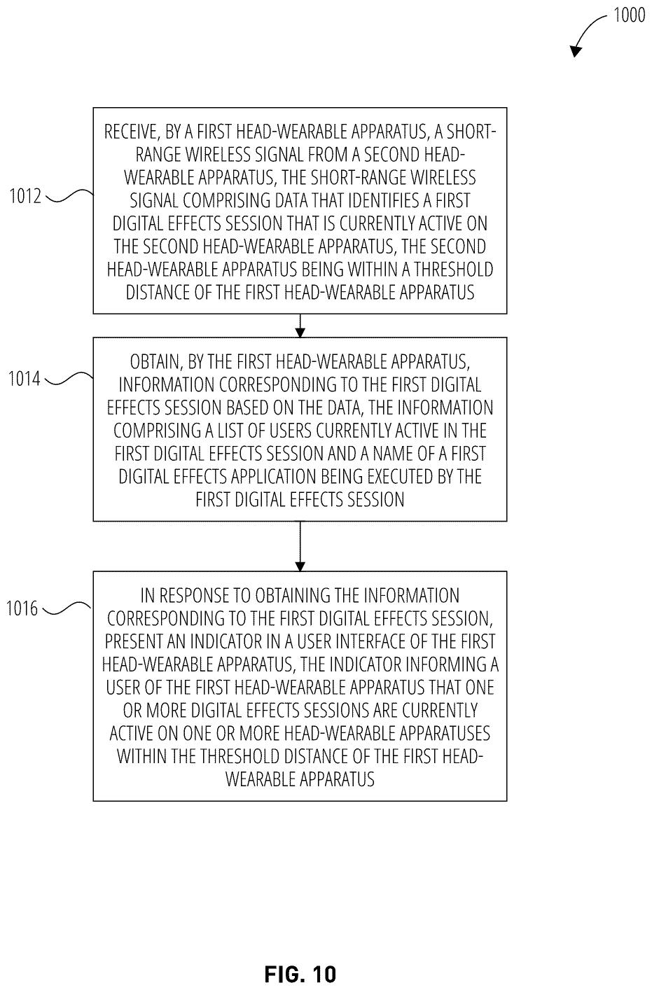

FIG. 10 is a flowchart illustrating routine 1000 (e.g., a method or process), according to some examples, of providing multiplayer AR experiences on a head-wearable apparatus.

Although the example method depicted in FIG. 10 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 1012, routine 1000 receives, by a first head-wearable apparatus 116, a short-range wireless signal from a second head-wearable apparatus 116, the short-range wireless signal comprising data that identifies a first digital effects session that is currently active on the second head-wearable apparatus, the second head-wearable apparatus being within a threshold distance of the first head-wearable apparatus, as discussed above.

In operation 1014, routine 1000 obtains, by the first head-wearable apparatus 116, information corresponding to the first digital effects session based on the data, the information comprising a list of users currently active in the first digital effects session and a name of a first digital effects application being executed by the first digital effects session, as discussed above.

In operation 1016, routine 1000 in response to obtaining the information corresponding to the first digital effects session, presents an indicator in a user interface of the first head-wearable apparatus 116, the indicator informing a user of the first head-wearable apparatus 116 that one or more digital effects sessions are currently active on one or more head-wearable apparatuses within the threshold distance of the first head-wearable apparatus, as discussed above.

### System With Head-Wearable Apparatus

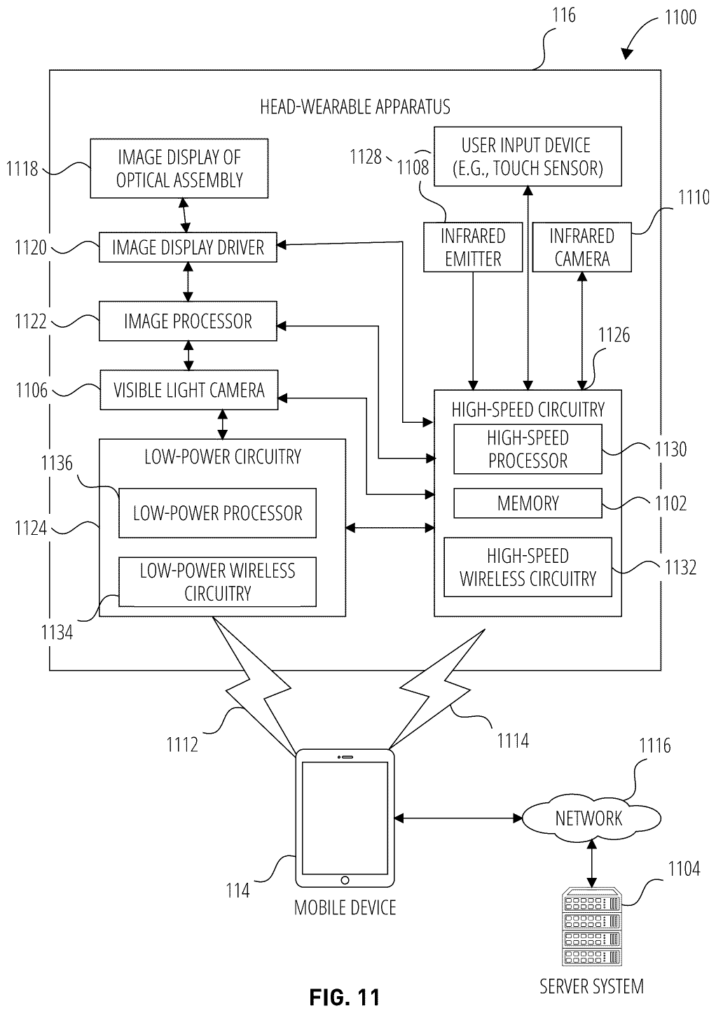

FIG. 11 illustrates a system 1100 including a head-wearable apparatus 116 with a selector input device, according to some examples. FIG. 11 is a high-level functional block diagram of an example head-wearable apparatus 116 communicatively coupled to a mobile device 114 and various server systems 1104 (e.g., the server system 110) via various networks 1116.

The head-wearable apparatus 116 includes one or more cameras, each of which may be, for example, a visible light camera 1106, an infrared emitter 1108, and an infrared camera 1110.

The mobile device 114 connects with head-wearable apparatus 116 using both a low-power wireless connection 1112 and a high-speed wireless connection 1114. The mobile device 114 is also connected to the server system 1104 and the Network 1116.

The head-wearable apparatus 116 further includes two image displays of the image display of optical assembly 1118. The two image displays of optical assembly 1118 include one associated with the left lateral side and one associated with the right lateral side of the head-wearable apparatus 116. The head-wearable apparatus 116 also includes an image display driver 1120, an image Processor 1122, low-power circuitry 1124, and high-speed circuitry 1126. The image display of optical assembly 1118 is for presenting images and videos, including an image that can include a graphical user interface to a user of the head-wearable apparatus 116.

The image display driver 1120 commands and controls the image display of optical assembly 1118. The image display driver 1120 may deliver image data directly to the image display of optical assembly 1118 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1128 (e.g., touch sensor or push button), including an input surface on the head-wearable apparatus 116. The user input device 1128 (e.g., touch sensor or push button) is to receive from the user an input selection to manipulate the graphical user interface of the presented image.

The components shown in FIG. 11 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1106 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1102, which stores instructions to perform a subset, or all the functions described herein. The memory 1102 can also include storage device.

As shown in FIG. 11, the high-speed circuitry 1126 includes a high-speed Processor 1130, a memory 1102, and high-speed wireless circuitry 1132. In some examples, the image display driver 1120 is coupled to the high-speed circuitry 1126 and operated by the high-speed Processor 1130 to drive the left and right image displays of the image display of optical assembly 1118. The high-speed Processor 1130 may be any processor capable of managing high-speed communications and operation of any general computing system needed for the head-wearable apparatus 116. The high-speed Processor 1130 includes processing resources needed for managing high-speed data transfers on a high-speed wireless connection 1114 to a wireless local area network (WLAN) using the high-speed wireless circuitry 1132. In certain examples, the high-speed Processor 1130 executes an operating system such as a LINUX operating system or other such operating system of the head-wearable apparatus 116, and the operating system is stored in the memory 1102 for execution. In addition to any other responsibilities, the high-speed Processor 1130 executing a software architecture for the head-wearable apparatus 116 is used to manage data transfers with high-speed wireless circuitry 1132. In certain examples, the high-speed wireless circuitry 1132 is configured to implement Institute of Electrical and Electronic Engineers (IEEE) 802.11 communication standards, also referred to herein as WI-FI®. In some examples, other high-speed communications standards may be implemented by the high-speed wireless circuitry 1132.

The low-power wireless circuitry 1134 and the high-speed wireless circuitry 1132 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 1112 and the high-speed wireless connection 1114, may be implemented using details of the architecture of the head-wearable apparatus 116, as can other elements of the Network 1116.

The memory 1102 includes any storage device capable of storing various data and applications, including, among other things, camera data generated by the left and right visible light cameras 1106, the infrared camera 1110, and the image Processor 1122, as well as images generated for display by the image display driver 1120 on the image displays of the image display of optical assembly 1118. While the memory 1102 is shown as integrated with high-speed circuitry 1126, in some examples, the memory 1102 may be an independent standalone element of the head-wearable apparatus 116. In certain such examples, electrical routing lines may provide a connection through a chip that includes the high-speed Processor 1130 from the image Processor 1122 or the low-power Processor 1136 to the memory 1102. In some examples, the high-speed Processor 1130 may manage addressing of the memory 1102 such that the low-power Processor 1136 will boot the high-speed Processor 1130 any time that a read or write operation involving memory 1102 is needed.

As shown in FIG. 11, the low-power Processor 1136 or high-speed Processor 1130 of the head-wearable apparatus 116 can be coupled to the camera (visible light camera 1106, infrared emitter 1108, or infrared camera 1110), the image display driver 1120, the user input device 1128 (e.g., touch sensor or push button), and the memory 1102.

The head-wearable apparatus 116 is connected to a host computer. For example, the head-wearable apparatus 116 is paired with the mobile device 114 via the high-speed wireless connection 1114 or connected to the server system 1104 via the Network 1116. The server system 1104 may be one or more computing devices as part of a service or network computing system, for example, that includes a processor, a memory, and network communication interface to communicate over the Network 1116 with the mobile device 114 and the head-wearable apparatus 116.

The mobile device 114 includes a processor and a Network communication interface coupled to the processor. The Network communication interface allows for communication over the Network 1116, low-power wireless connection 1112, or high-speed wireless connection 1114. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1120. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1104, such as the user input device 1128, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1112 and high-speed wireless connection 1114 from the mobile device 114 via the low-power wireless circuitry 1134 or high-speed wireless circuitry 1132.

### Machine Architecture

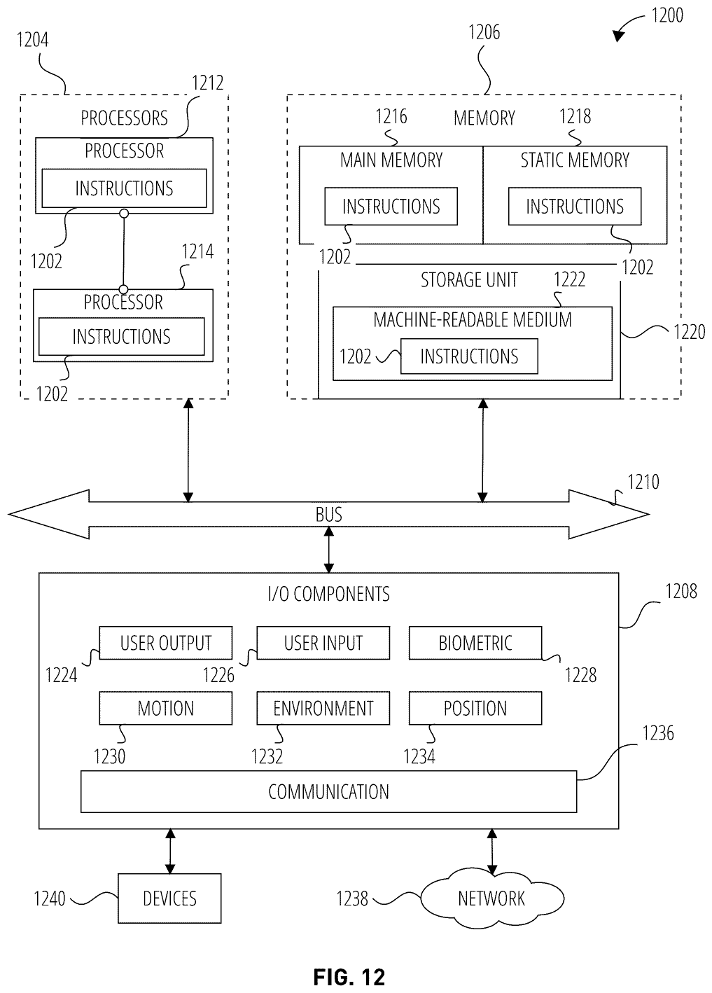

FIG. 12 is a diagrammatic representation of the machine 1200 within which instructions 1202 (e.g., software, a program, an application, an applet, an app, or other executable code) for causing the machine 1200 to perform any one or more of the methodologies discussed herein may be executed. For example, the instructions 1202 may cause the machine 1200 to execute any one or more of the methods described herein. The instructions 1202 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1202, sequentially or otherwise, that specify actions to be taken by the machine 1200. Further, while a single machine 1200 is illustrated, the term “machine” shall also be taken to include a collection of machines that individually or jointly execute the instructions 1202 to perform any one or more of the methodologies discussed herein. The machine 1200, for example, may comprise the user system 102 or any one of multiple server devices forming part of the server system 110. In some examples, the machine 1200 may also comprise both client and server systems, with certain operations of a particular method or algorithm being performed on the server-side and with certain operations of the method or algorithm being performed on the client-side.

The machine 1200 may include Processors 1204, memory 1206, and input/output I/O components 1208, which may be configured to communicate with each other via a bus 1210.

The memory 1206 includes a main memory 1216, a static memory 1218, and a storage unit 1220, both accessible to the Processors 1204 via the bus 1210. The main memory 1206, the static memory 1218, and storage unit 1220 store the instructions 1202 embodying any one or more of the methodologies or functions described herein. The instructions 1202 may also reside, completely or partially, within the main memory 1216, within the static memory 1218, within machine-readable medium 1222 within the storage unit 1220, within at least one of the Processors 1204 (e.g., within the processor's cache memory), or any suitable combination thereof, during execution thereof by the machine 1200.

The I/O components 1208 may include a wide variety of components to receive input, provide output, produce output, transmit information, exchange information, capture measurements, and so on. The specific I/O components 1208 that are included in a particular machine will depend on the type of machine. For example, portable machines such as mobile phones may include a touch input device or other such input mechanisms, while a headless server machine will likely not include such a touch input device. It will be appreciated that the I/O components 1208 may include many other components that are not shown in FIG. 12. In various examples, the I/O components 1208 may include user output components 1224 and user input components 1226. The user output components 1224 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1208 may include biometric components 1228, motion components 1230, environmental components 1232, or position components 1234, among a wide array of other components. For example, the biometric components 1228 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1230 include acceleration sensor components (e.g., accelerometer), gravitation sensor components, rotation sensor components (e.g., gyroscope).

The environmental components 1232 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1208 further include communication components 1236 operable to couple the machine 1200 to a Network 1238 or devices 1240 via respective coupling or connections. For example, the communication components 1236 may include a network interface component or another suitable device to interface with the Network 1238. In further examples, the communication components 1236 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1240 may be another machine or any of a wide variety of peripheral devices (e.g., a peripheral device coupled via a USB).

Moreover, the communication components 1236 may detect identifiers or include components operable to detect identifiers. For example, the communication components 1236 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1236, such as location via Internet Protocol (IP) geolocation, location via Wi-Fi® signal triangulation, location via detecting an NFC beacon signal that may indicate a particular location, and so forth.

The various memories (e.g., main memory 1216, static memory 1218, and memory of the Processors 1204) and storage unit 1220 may store one or more sets of instructions and data structures (e.g., software) embodying or used by any one or more of the methodologies or functions described herein. These instructions (e.g., the instructions 1202), when executed by Processors 1204, cause various operations to implement the disclosed examples.

The instructions 1202 may be transmitted or received over the Network 1238, using a transmission medium, via a network interface device (e.g., a network interface component included in the communication components 1236) and using any one of several well-known transfer protocols (e.g., hypertext transfer protocol (HTTP)). Similarly, the instructions 1202 may be transmitted or received using a transmission medium via a coupling (e.g., a peer-to-peer coupling) to the devices 1240.

### Software Architecture

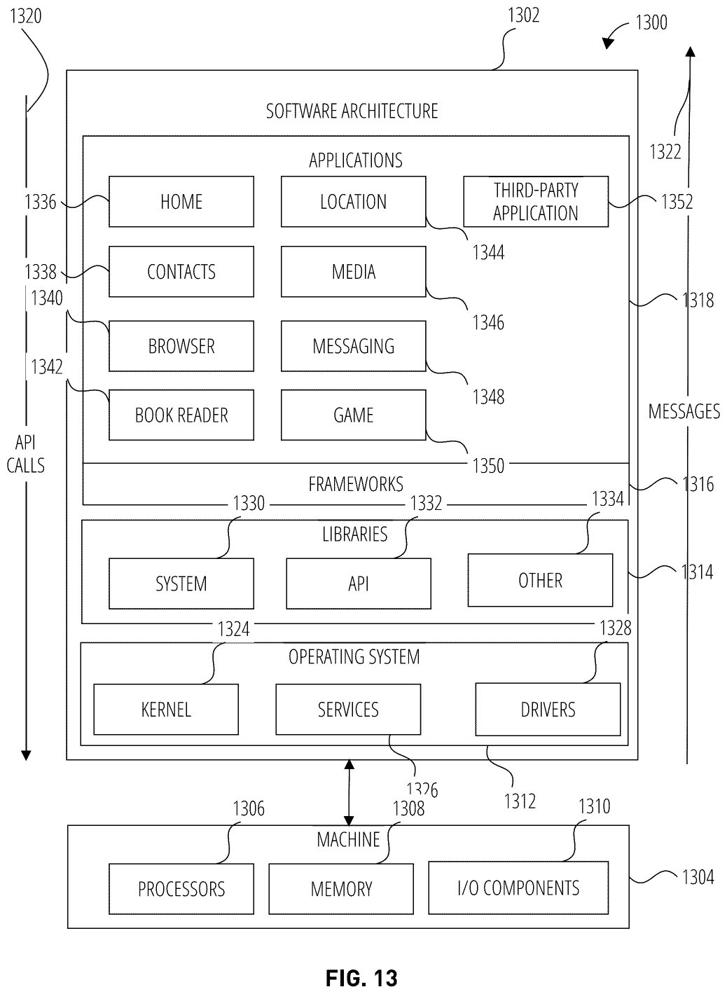

FIG. 13 is a block diagram 1300 illustrating a software architecture 1302, which can be installed on any one or more of the devices described herein. The software architecture 1302 is supported by hardware such as a machine 1304 that includes Processors 1306, memory 1308, and I/O components 1310. In this example, the software architecture 1302 can be conceptualized as a stack of layers, where each layer provides a particular functionality. The software architecture 1302 includes layers such as an operating system 1312, libraries 1314, frameworks 1316, and applications 1318. Operationally, the applications 1318 invoke API calls 1320 through the software stack and receive messages 1322 in response to the API calls 1320.

The operating system 1312 manages hardware resources and provides common services. The operating system 1312 includes, for example, a kernel 1324, services 1326, and drivers 1328. The kernel 1324 acts as an abstraction layer between the hardware and the other software layers. For example, the kernel 1324 provides memory management, processor management (e.g., scheduling), component management, networking, and security settings, among other functionalities. The services 1326 can provide other common services for the other software layers. The drivers 1328 are responsible for controlling or interfacing with the underlying hardware. For instance, the drivers 1328 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1314 provide a common low-level infrastructure used by the applications 1318. The libraries 1314 can include system libraries 1330 (e.g., C standard library) that provide functions such as memory allocation functions, string manipulation functions, mathematical functions, and the like. In addition, the libraries 1314 can include API libraries 1332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1314 can also include a wide variety of other libraries 1334 to provide many other APIs to the applications 1318.

The frameworks 1316 provide a common high-level infrastructure that is used by the applications 1318. For example, the frameworks 1316 provide various graphical user interface (GUI) functions, high-level resource management, and high-level location services. The frameworks 1316 can provide a broad spectrum of other APIs that can be used by the applications 1318, some of which may be specific to a particular operating system or platform.

In an example, the applications 1318 may include a home application 1336, a contacts application 1338, a browser application 1340, a book reader application 1342, a location application 1344, a media application 1346, a messaging application 1348, a game application 1350, and a broad assortment of other applications such as a third-party application 1352. The applications 1318 are programs that execute functions defined in the programs. Various programming languages can be employed to create one or more of the applications 1318, structured in a variety of manners, such as object-oriented programming languages (e.g., Objective-C, Java, or C++) or procedural programming languages (e.g., C or assembly language). In a specific example, the third-party application 1352 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1352 can invoke the API calls 1320 provided by the operating system 1312 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C. ” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1. A system comprising: at least one processor; at least one memory component storing instructions that, when executed by the at least one processor, cause the at least one processor to perform operations comprising: receiving, by a first head-wearable apparatus, a short-range wireless signal from a second head-wearable apparatus, the short-range wireless signal comprising data that identifies a first digital effects session that is currently active on the second head-wearable apparatus, the second head-wearable apparatus being within a threshold distance of the first head-wearable apparatus; obtaining, by the first head-wearable apparatus, information corresponding to the first digital effects session based on the data, the information comprising a list of users currently active in the first digital effects session and a name of a first digital effects application being executed by the first digital effects session; and in response to obtaining the information corresponding to the first digital effects session, presenting an indicator in a user interface of the first head-wearable apparatus, the indicator informing a user of the first head-wearable apparatus that one or more digital effects sessions are currently active on one or more head-wearable apparatuses within the threshold distance of the first head-wearable apparatus.

Example 2. The system of clause 1, wherein the first digital effects application comprises an augmented reality (AR) experience, and wherein the short-range wireless signal is a broadcast signal that comprises at least one of a Bluetooth signal, a Bluetooth low energy (BLE) signal, a WiFi signal, or an extended Bluetooth signal.

Example 3. The system of any one of Examples 1-2, wherein the operations comprise: displaying, by the first head-wearable apparatus, a menu with a plurality of options associated with digital effects sessions, wherein a first option of the plurality of options corresponds to the one or more digital effects sessions that are active within the threshold distance of the first head-wearable apparatus; and in response to obtaining the information corresponding to the first digital effects session and in response to receiving the short-range wireless signal from the second head-wearable apparatus, presenting an icon within the first option as the indicator.

Example 4. The system of any one of Examples 1-3, wherein the operations comprise: receiving input that selects the first option; and in response to receiving the input that selects the first option, presenting one or more tiles each associated with a different digital effects session that is active within the threshold distance of the first head-wearable apparatus, wherein a first tile of the one or more tiles is associated with the first digital effects session corresponding to the obtained information, the first tile comprising an image that represents the first digital effects session, one or more avatars of list of users currently active in the first digital effects session, and the name of the first digital effects application.

Example 5. The system of any one of Examples 1-4, wherein the operations comprise: sorting the one or more tiles based on timestamps indicating recency of activation of the respective digital effects session, a most recently activated digital effects session being representing by a tile positioned above or earlier in a list than another tile of a digital effects session that has been later activated.

Example 6. The system of any one of Examples 1-5, wherein the operations comprise: receiving input that selects the first tile; and in response to receiving the input that selects the first tile, activating the first digital effects session on the first head-wearable apparatus and adding a user of the first head-wearable apparatus to the list of users of the first digital effects session, the activation of the first digital effects session being performed automatically and without presenting an option for the user to join the first digital effects session.

Example 7. The system of any one of Examples 1-6, wherein the operations comprise: receiving mapping information associated with a real-world environment for the first digital effects session, the mapping information having been generated by the second head-wearable apparatus during activation of the first digital effects session; presenting an animation on the first head-wearable apparatus associated with aligning a space of the first head-wearable apparatus to the mapping information of the real-world environment; and presenting a progress bar representing status of aligning the space of the first head-wearable apparatus to the mapping information of the real-world environment.

Example 8. The system of any one of Examples 1-7, wherein each of the one or more tiles is presented with a visual indicator representing a current status of the respective digital effects session, the current status comprising at least one of connecting state, active state, hover state, everyone left state, or an out-of-range state.

Example 9. The system of any one of Examples 1-8, wherein the operations comprise: presenting the first tile with the connecting state as the current status in response to determining that the second head-wearable apparatus has activated the first digital effects session and is currently mapping a real-world environment of the second head-wearable apparatus; and transitioning the first tile from the connecting state to the active state in response to determining that the second head-wearable apparatus has completed mapping the real-world environment of the second head-wearable apparatus.

Example 10. The system of any one of Examples 1-9, wherein the operations comprise: presenting the first tile in the hover state in response to receiving input from the first head-wearable apparatus that identifies the first tile; and presenting the first tile in the everyone left state in response to detecting that the list of users currently active in the first digital effects session is empty.

Example 11. The system of any one of Examples 1-10, wherein the operations comprise: presenting the first tile in the out-of-range state in response to determining that the first head-wearable apparatus is beyond a threshold distance from the second head-wearable apparatus.

Example 12. The system of any one of Examples 1-11, wherein the operations comprise: activating the first digital effects session by the second head-wearable apparatus, the activating comprising: presenting an icon associated with the first digital effects application on the second head-wearable apparatus; receiving input that selects the icon on the second head-wearable apparatus; in response to receiving the input, presenting a plurality of options comprising a first option to launch the first digital effects application in single player mode and a second option to launch the first digital effects application in multiplayer mode; and receiving a selection of the second option to activate the first digital effects session using the first digital effects application.

Example 13. The system of any one of Examples 1-12, wherein the operations comprise: in response to receiving the selection of the second option, presenting an animation of a plurality of avatars mapping a real-world environment by viewing a same set of objects from different angles.

Example 14. The system of any one of Examples 1-13, wherein the operations comprise: as the second head-wearable apparatus is moved around to map the real-world environment according to the animation, presenting a progress bar indicating progress in mapping the real-world environment.

Example 15. The system of any one of Examples 1-14, wherein the operations comprise: presenting one or more hints for improving the mapping of the real-world environment, the one or more hints comprising at least one of a first hint to ensure surroundings have objects and patterns, a second hint to avoid plain solid colored walls, a third hint to move steadily, or a fourth hint to improve lighting conditions.

Example 16. The system of any one of Examples 1-15, wherein the one or more hints respectively fade in and fade out gradually over time.

Example 17. The system of any one of Examples 1-16, wherein the operations comprise: after mapping of the real-world environment has been completed, determining that a new user associated with the first head-wearable apparatus has joined the first digital effects session.

Example 18. The system of any one of Examples 1-17, wherein the operations comprise: in response to determining that the new user associated with the first head-wearable apparatus has joined the first digital effects session, presenting on the second head-wearable apparatus an animation to assist a user of the second head-wearable apparatus to position the new user at an individual real-world location that matches a prior real-world location used by the user of the second head-wearable apparatus to map the real-world environment.

Example 19. A computer-implemented method comprising: receiving, by a first head-wearable apparatus, a short-range wireless signal from a second head-wearable apparatus, the short-range wireless signal comprising data that identifies a first digital effects session that is currently active on the second head-wearable apparatus, the second head-wearable apparatus being within a threshold distance of the first head-wearable apparatus; obtaining, by the first head-wearable apparatus, information corresponding to the first digital effects session based on the data, the information comprising a list of users currently active in the first digital effects session and a name of a first digital effects application being executed by the first digital effects session; and in response to obtaining the information corresponding to the first digital effects session, presenting an indicator in a user interface of the first head-wearable apparatus, the indicator informing a user of the first head-wearable apparatus that one or more digital effects sessions are currently active on one or more head-wearable apparatuses within the threshold distance of the first head-wearable apparatus.

Example 20. A non-transitory computer-readable storage medium storing instructions that, when executed by at least one processor, cause the at least one processor to perform operations comprising: receiving, by a first head-wearable apparatus, a short-range wireless signal from a second head-wearable apparatus, the short-range wireless signal comprising data that identifies a first digital effects session that is currently active on the second head-wearable apparatus, the second head-wearable apparatus being within a threshold distance of the first head-wearable apparatus; obtaining, by the first head-wearable apparatus, information corresponding to the first digital effects session based on the data, the information comprising a list of users currently active in the first digital effects session and a name of a first digital effects application being executed by the first digital effects session; and in response to obtaining the information corresponding to the first digital effects session, presenting an indicator in a user interface of the first head-wearable apparatus, the indicator informing a user of the first head-wearable apparatus that one or more digital effects sessions are currently active on one or more head-wearable apparatuses within the threshold distance of the first head-wearable apparatus.

Example 21 is an apparatus comprising means to implement of any of the above Examples.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
receiving, by a first head-wearable apparatus, a short-range wireless signal from a second head-wearable apparatus, the short-range wireless signal comprising data that identifies a first digital effects session that is currently active on the second head-wearable apparatus, the second head-wearable apparatus being within a threshold distance of the first head-wearable apparatus;
obtaining, by the first head-wearable apparatus, information corresponding to the first digital effects session based on the data, the information comprising a list of users currently active in the first digital effects session and a name of a first digital effects application being executed by the first digital effects session; and
in response to obtaining the information corresponding to the first digital effects session, presenting an indicator in a user interface of the first head-wearable apparatus, the indicator informing a user of the first head-wearable apparatus that one or more digital effects sessions are currently active on one or more head-wearable apparatuses within the threshold distance of the first head-wearable apparatus.

2. The system of claim 1, wherein the first digital effects application comprises an augmented reality (AR) experience, and wherein the short-range wireless signal is a broadcast signal that comprises at least one of a Bluetooth signal, a Bluetooth low energy (BLE) signal, a WiFi signal, or an extended Bluetooth signal.

3. The system of claim 1, wherein the operations comprise:
displaying, by the first head-wearable apparatus, a menu with a plurality of options associated with digital effects sessions, wherein a first option of the plurality of options corresponds to the one or more digital effects sessions that are active within the threshold distance of the first head-wearable apparatus; and
in response to obtaining the information corresponding to the first digital effects session and in response to receiving the short-range wireless signal from the second head-wearable apparatus, presenting an icon within the first option as the indicator.

4. The system of claim 3, wherein the operations comprise:
receiving input that selects the first option; and
in response to receiving the input that selects the first option, presenting one or more tiles each associated with a different digital effects session that is active within the threshold distance of the first head-wearable apparatus, wherein a first tile of the one or more tiles is associated with the first digital effects session corresponding to the obtained information, the first tile comprising an image that represents the first digital effects session, one or more avatars of list of users currently active in the first digital effects session, and the name of the first digital effects application.

5. The system of claim 4, wherein the operations comprise:
sorting the one or more tiles based on timestamps indicating recency of activation of the respective digital effects session, a most recently activated digital effects session being representing by a tile positioned above or earlier in a list than another tile of a digital effects session that has been later activated.

6. The system of claim 4, wherein the operations comprise:
receiving input that selects the first tile; and
in response to receiving the input that selects the first tile, activating the first digital effects session on the first head-wearable apparatus and adding a user of the first head-wearable apparatus to the list of users of the first digital effects session, the activation of the first digital effects session being performed automatically and without presenting an option for the user to join the first digital effects session.

7. The system of claim 6, wherein the operations comprise:
receiving mapping information associated with a real-world environment for the first digital effects session, the mapping information having been generated by the second head-wearable apparatus during activation of the first digital effects session;
presenting an animation on the first head-wearable apparatus associated with aligning a space of the first head-wearable apparatus to the mapping information of the real-world environment; and
presenting a progress bar representing status of aligning the space of the first head-wearable apparatus to the mapping information of the real-world environment.

8. The system of claim 4, wherein each of the one or more tiles is presented with a visual indicator representing a current status of the respective digital effects session, the current status comprising at least one of connecting state, active state, hover state, everyone left state, or an out of range state.

9. The system of claim 8, wherein the operations comprise:
presenting the first tile with the connecting state as the current status in response to determining that the second head-wearable apparatus has activated the first digital effects session and is currently mapping a real-world environment of the second head-wearable apparatus; and
transitioning the first tile from the connecting state to the active state in response to determining that the second head-wearable apparatus has completed mapping the real-world environment of the second head-wearable apparatus.

10. The system of claim 9, wherein the operations comprise:
presenting the first tile in the hover state in response to receiving input from the first head-wearable apparatus that identifies the first tile; and
presenting the first tile in the everyone left state in response to detecting that the list of users currently active in the first digital effects session is empty.

11. The system of claim 9, wherein the operations comprise:
presenting the first tile in the out of range state in response to determining that the first head-wearable apparatus is beyond a threshold distance from the second head-wearable apparatus.

12. The system of claim 1, wherein the operations comprise:
activating the first digital effects session by the second head-wearable apparatus, the activating comprising:
presenting an icon associated with the first digital effects application on the second head-wearable apparatus;
receiving input that selects the icon on the second head-wearable apparatus;
in response to receiving the input, presenting a plurality of options comprising a first option to launch the first digital effects application in single player mode and a second option to launch the first digital effects application in multiplayer mode; and
receiving a selection of the second option to activate the first digital effects session using the first digital effects application.

13. The system of claim 12, wherein the operations comprise:
in response to receiving the selection of the second option, presenting an animation of a plurality of avatars mapping a real-world environment by viewing a same set of objects from different angles.

14. The system of claim 13, wherein the operations comprise:
as the second head-wearable apparatus is moved around to map the real-world environment according to the animation, presenting a progress bar indicating progress in mapping the real-world environment.

15. The system of claim 13, wherein the operations comprise:
presenting one or more hints for improving the mapping of the real-world environment, the one or more hints comprising at least one of a first hint to ensure surroundings have objects and patterns, a second hint to avoid plain solid colored walls, a third hint to move steadily, or a fourth hint to improve lighting conditions.

16. The system of claim 15, wherein the one or more hints respectively fade in and fade out gradually over time.

17. The system of claim 13, wherein the operations comprise:
after mapping of the real-world environment has been completed, determining that a new user associated with the first head-wearable apparatus has joined the first digital effects session.

18. The system of claim 17, wherein the operations comprise:
in response to determining that the new user associated with the first head-wearable apparatus has joined the first digital effects session, presenting on the second head-wearable apparatus a new animation to assist a user of the second head-wearable apparatus to position the new user at an individual real-world location that matches a prior real-world location used by the user of the second head-wearable apparatus to map the real-world environment.

19. A computer-implemented method comprising:
receiving, by a first head-wearable apparatus, a short-range wireless signal from a second head-wearable apparatus, the short-range wireless signal comprising data that identifies a first digital effects session that is currently active on the second head-wearable apparatus, the second head-wearable apparatus being within a threshold distance of the first head-wearable apparatus;
obtaining, by the first head-wearable apparatus, information corresponding to the first digital effects session based on the data, the information comprising a list of users currently active in the first digital effects session and a name of a first digital effects application being executed by the first digital effects session; and
in response to obtaining the information corresponding to the first digital effects session, presenting an indicator in a user interface of the first head-wearable apparatus, the indicator informing a user of the first head-wearable apparatus that one or more digital effects sessions are currently active on one or more head-wearable apparatuses within the threshold distance of the first head-wearable apparatus.

20. A non-transitory computer-readable storage medium storing instructions that, when executed by at least one processor, cause the at least one processor to perform operations comprising:
receiving, by a first head-wearable apparatus, a short-range wireless signal from a second head-wearable apparatus, the short-range wireless signal comprising data that identifies a first digital effects session that is currently active on the second head-wearable apparatus, the second head-wearable apparatus being within a threshold distance of the first head-wearable apparatus;
obtaining, by the first head-wearable apparatus, information corresponding to the first digital effects session based on the data, the information comprising a list of users currently active in the first digital effects session and a name of a first digital effects application being executed by the first digital effects session; and
in response to obtaining the information corresponding to the first digital effects session, presenting an indicator in a user interface of the first head-wearable apparatus, the indicator informing a user of the first head-wearable apparatus that one or more digital effects sessions are currently active on one or more head-wearable apparatuses within the threshold distance of the first head-wearable apparatus.
